(19) United States
(12) Patent Application Publication
(10) Pub. No.: US 2008/0191044 A1
(43) Pub. Date: Aug. 14, 2008

(54) TEMPERATURE CONTROL METHOD FOR MULTI-TYPE AIR CONDITIONER AND APPARATUS THEREFOR

(75) Inventors: Han-Won PARK, Seoul (KR); Sang-Chul YOUN, Seoul (KR); Duck-Gu JEON, Seoul (KR)

Correspondence Address: GREENBLUM & BERNSTEIN, P.L.C., 1950 ROLAND CLARKE PLACE, RESTON, VA, 20191, US

(73) Assignee: LG ELECTRONICS INC., Seoul (KR)

(21) Appl. No.: 11/972,218

(22) Filed: Jan. 10, 2008

(30) Foreign Application Priority Data
Feb. 8, 2007 (KR) 10-2007-0013385

(51) Int. Cl. G05D 23/00

(52) U.S. Cl. 236/51

(57) ABSTRACT

Disclosed are a temperature control method and apparatus for a multi-type air conditioner which are capable of maintaining a pleasant indoor environment and increasing energy efficiency by automatically controlling a temperature setting for a multi-type air conditioner's operation within a desired temperature range and maintaining it thereat, by controlling or preventing an undesirable temperature setting input at an indoor unit.

### BACKGROUND OF THE INVENTION

1. Field of the Invention

The present invention relates to a temperature control method for a multi-type air conditioner and an apparatus therefor, and more particularly, to a temperature control method for a multi-type air conditioner and apparatus therefor which are capable of maintaining a pleasant indoor environment and increasing energy efficiency by automatically controlling a setting temperature for a multi-type air conditioner's operation within a desired temperature range and maintaining thereof, or by controlling or preventing a temperature input from an indoor unit.

2. Description of the Background Art

FIG. 1 schematically illustrates a structure of a related art multi-type air conditioner.

As shown in FIG. 1, the multi-type air conditioner includes one or more outdoor units 120 to which a plurality of indoor units 110 is connected, a central control unit 130 for performing a central control function of the outdoor units 120 to which the indoor units 110 are connected, and platforms 140 disposed between the outdoor units 120 and the central control unit 130 and connecting the indoor units 110 and the central control unit 130.

In general, the related art multi-type air conditioner is controlled in a manner in which a desired temperature is set in the central control unit 130 and then a command is transmitted to each of the indoor units 110 and the outdoor units 120 through the platforms 140, and the indoor units 110 and the outdoor units 120 are operated according to the command of the central control unit 130.

However, in the related art method for controlling the multi-type air conditioner, if a user selects a mode among a cooling mode or a heating mode, sets a desired temperature to operate the multi-type air conditioner, and enters a command, the indoor units 110 and the outdoor units 120 are operated by the command. When the user enters a command to set the temperature, the system may not work properly or the user may enter an unnecessary temperature command, thereby reducing a pleasant atmosphere.

In addition, in the related art method for controlling the multi-type air conditioner, if a temperature outside of a temperature range set at the central control unit 130 is set by using a temperature control unit (not shown) equipped at each of the indoor units 110, then the indoor units 110 are operated according to the temperature set at the indoor units 110, thereby causing unnecessary cooling and heating and thus wasting energy.

### SUMMARY OF THE INVENTION

Therefore, it is an object of the present invention to provide a temperature control method for a multi-type air conditioner which is capable of maintaining a pleasant indoor environment and increasing energy efficiency by automatically controlling a temperature setting for a multi-type air conditioner's operation within a desired temperature range and the maintaining it thereat, or by controlling or preventing an undesirable temperature setting input at an indoor unit.

To achieve these and other advantages and in accordance with the purpose of the present invention, as embodied and broadly described herein, there is provided a temperature control method for a multi-type air conditioner according to a first embodiment of the present invention, comprising: receiving, by a central control unit, a desired temperature range inputted by a user; comparing the inputted desired temperature range with a preset limit temperature range; and if the inputted desired temperature range is within the preset limit temperature range, operating an indoor unit of the multi-type air conditioner according to the inputted desired temperature range.

Here, the temperature control method for the multi-type air conditioner according to the first embodiment of the present invention may further include the step of pre-setting a limit temperature range at the central control unit. In addition, preferably, the method further includes the step of re-inputting the desired temperature range if the inputted temperature range is outside of the preset limit temperature range. The method may further include the step of outputting an error message if the inputted temperature range is outside of the preset temperature range.

To achieve these and other advantages and in accordance with the purpose of the present invention, as embodied and broadly described herein, there is provided the temperature control method for a multi-type air conditioner according to a second embodiment of the present invention, comprising: inputting, at any of one or more indoor units, a desired temperature; determining whether the inputted temperature is within a preset temperature range; and operating the indoor units based on the determination result.

Here, the method may further include the step of re-inputting a new desired temperature if the previously inputted desired temperature is outside of the preset temperature range. In addition, the method may further include the step of transmitting the preset temperature range and an error message to the indoor units if the inputted temperature is outside of the preset temperature range.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate preferred embodiments of the invention and together with the description serve to explain the principles of the invention.

In the drawings:

FIG. 1 is a block diagram which schematically illustrates the structure of a related art multi-type air conditioner;

FIG. 2 is a flowchart illustrating a temperature control method for a multi-type air conditioner according to a first embodiment of the present invention;

FIG. 3 is a block diagram schematically illustrating a temperature control apparatus for a multi-type air conditioner according to a second embodiment of the present invention; and

FIG. 4 is a flowchart illustrating a temperature control method for a multi-type air conditioner according to the second embodiment of the present invention.

### DETAILED DESCRIPTION OF THE INVENTION

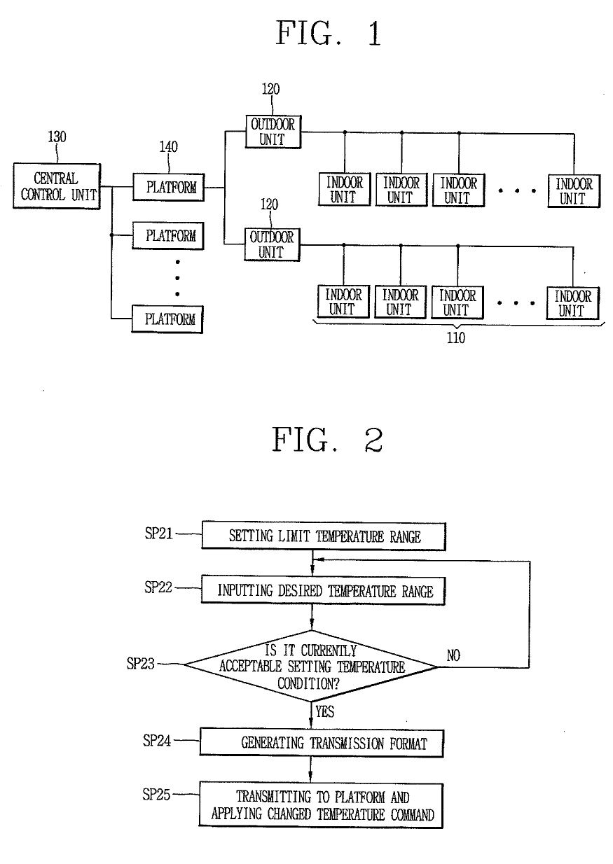

Description will now be given in detail of the preferred embodiments of the present invention with reference to FIG. 2 which is a flowchart illustrating the temperature control method for a multi-type air conditioner according to a first embodiment of the present invention. Here, the method is described with reference to the block diagram of the apparatus shown in FIG. 1.

Referring to FIG. 2, the temperature control method for the multi-type air conditioner according to the first embodiment of the present invention sequentially proceeds from the steps of setting a limit temperature range (SP21), inputting a desired temperature range (SP22), determining whether the desired temperature range is a valid (acceptable) setting temperature condition by comparing the desired temperature range with the limit temperature range (SP23), generating a transmission format according to the temperature setting (SP24), and transmitting the transmission format to a platform and applying a changed temperature command (SP25).

A manager or user inputs a maximum temperature and a minimum temperature to the central control unit 130 in advance, and sets the limit temperature range in a database, a file or the like. If the user inputs a desired temperature range to the central control unit 130, the central control unit 130 determines whether the desired temperature range is within a preset limit temperature range. If the desired temperature range inputted to the central control unit 130 is determined to be valid (acceptable), the inputted temperature range is set as a setting temperature range for operating the multi-type air conditioner. A transmission format is then generated based on the setting temperature range, and then is transmitted to the platform 140. Accordingly, the central control unit 130 transmits a setting temperature command to the indoor unit 110 and the outdoor unit 120 of the multi-type air conditioner. On the other hand, if the desired temperature range is determined not to be a valid setting, the central control unit 130 does not issue a temperature setting command, but transmits an error message prompting a user to input another acceptable temperature range again. With these operations, the user can set a temperature range within the preset limit temperature range, thereby controlling the multi-type air conditioner to operate in the effective temperature range.

Also, a temperature control apparatus for the multi-type air conditioner according to the first embodiment of the present invention, comprising: a central control unit that receives a desired temperature range setting from an indoor unit, compares the received desired temperature range setting with a preset limit temperature range, and operates the indoor unit according to the inputted desired temperature range if the inputted desired temperature range is within the preset limit temperature range. Here, the preset limit temperature range is preset at the central control unit. Also, the central control unit sends an error message to the input unit if the inputted desired temperature range is outside of the preset limit temperature range.

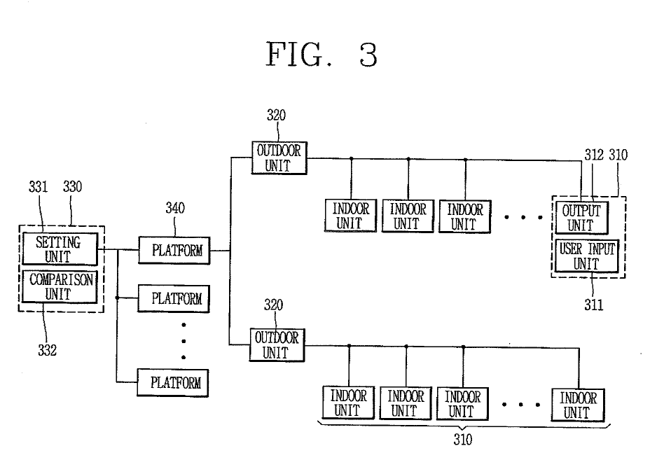

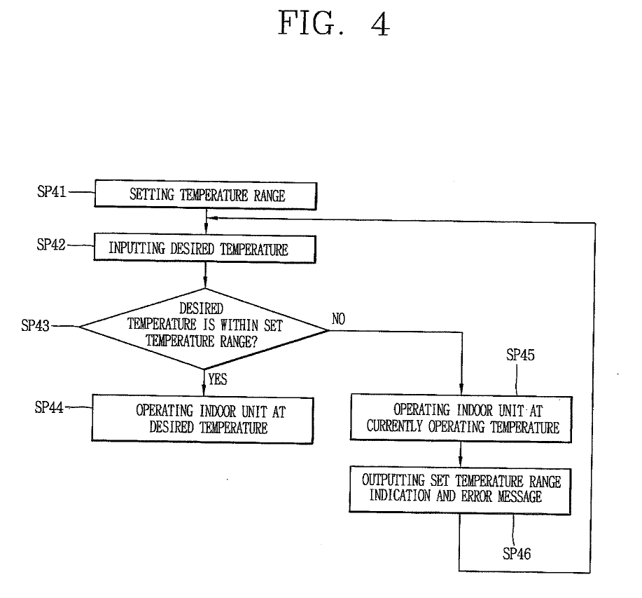

Hereinafter, the apparatus and method according to a second embodiment of the present invention will be described in detail with reference to FIGS. 3 and 4.

FIG. 3 is a block diagram schematically illustrating a temperature control apparatus for a multi-type air conditioner according to the second embodiment of the present invention, and FIG. 4 is a flowchart illustrating a temperature control method for a multi-type air conditioner according to the second embodiment of the present invention.

The temperature control apparatus for a multi-type air conditioner according to the second embodiment of the present invention, comprising: a central control unit that receives a desired temperature from an indoor unit, determines whether the desired temperature is within a preset temperature range, and operates the indoor unit based on the determination result.

Here, the temperature control apparatus may further include the indoor unit, the central control unit sends the preset temperature range and an error message to the indoor unit when the desired temperature is not within the preset temperature range, and the indoor unit comprises output unit that outputs an indication of the preset temperature range and the error message. Here, the central control unit also operates the indoor unit according to the desired temperature if the inputted temperature is within the preset temperature range.

Here, the central control unit comprises a setting unit that presets the is preset temperature range, and the setting unit presets a different preset temperature range for each of a plurality of indoor units of the multi-type air conditioner.

As shown in FIG. 3, the temperature control apparatus for the multi-type air conditioner according to the second embodiment of the present invention includes one or more indoor units 310, one or more outdoor units 320 each respectively connected to one or more respective indoor units 310, and a central control unit 330 for controlling the inputting of a desired temperature at any of the indoor units 310 so as to be within a preset temperature range and for controlling the operation of the indoor units 310 and the outdoor units 320 accordingly. In addition, a platform 340 is disposed between each of the outdoor units 320 and the central control unit 330 to connect the indoor units 310 and the central control unit 330. Here, the indoor units 310 may further include a user input unit 311 for enabling a user to input a temperature setting, and an output unit 312 for outputting a preset temperature range indication, an error message, and the like. Further, the central control unit 330 includes a setting unit 331 for setting a temperature range, and a comparison unit 332 for comparing whether or not an inputted desired temperature is within the preset temperature range.

Referring to FIG. 4, the temperature control method according to the second embodiment of the present invention includes a step of receiving, by a 10 central control unit of the multi-type air conditioner, a desired temperature inputted by a user at an indoor unit of the multi-type air conditioner (SP42), determining whether the inputted desired temperature is within a preset temperature range (SP43), and operating the concerned indoor unit based on the determination result (SP44 and SP45). In addition, the method according to the present invention may further include the step of, before the multi-type air conditioner is operated, setting a desired temperature range at the central control unit for performing a central control function of the multi-type air conditioner (SP41). And, although not shown, the method according to the present invention may further include the step of, while the multi-type air conditioner is being operated, resetting the preset temperature range to another temperature range.

If the manager inputs a range of maximum and minimum temperature through the setting unit 331 of the central control unit 330, the central control unit 330 checks whether the inputted value is effective. Based on the checked result, if the temperature range is determined to be effective, the central control unit 330 sets such temperature range as a temperature range of the multi-type air conditioner (SP41). Here, the central control unit 330 may set different temperature ranges in each of the outdoor units 320, each of the indoor units 310, or simultaneously to all multi-type air conditioners, or the like.

In addition, if a desired temperature is inputted from a user input unit 311 at the indoor unit 310 and transmitted to the central control unit 330, the central control unit 330 then determines whether the inputted desired temperature is within the preset temperature range (SP42 and SP43). Based on the determination result, if the desired temperature is within the preset temperature range, then the desired temperature is set as a target temperature to operate the indoor unit (SP44). On the other hand, based on the determination result, if the desired temperature is outside the preset temperature range, the indoor unit 310 is operated based on the currently set operating temperature, that is, according to the temperature setting which was previously inputted as the desired temperature and then set as the target temperature (SP45). If the inputted desired temperature is outside the preset temperature range, an error message is issued through the output unit 312 of the indoor unit to prompt the user to input a valid temperature setting. Simultaneously or separately, the central control unit 330 may output an indication of the valid (acceptable) input range, that is, the temperature range acceptable to be effectively set at each of the indoor units 310, through the output unit 312 of the concerned indoor unit 310. By these operations, the multi-type air conditioner can be controlled to operate within the temperature range which the manager sets through the central control unit 330.

Further, in the temperature control method for a multi-type air conditioner according to a further embodiment of the present invention, the platform 340 periodically monitors the desired temperature inputted at the indoor units 310 of the multi-type air conditioner, and if a desired temperature setting is outside of the preset temperature range, controls the temperature setting to be within the preset temperature range so as to operate the indoor units 310 and the outdoor units 320 of the multi-type air conditioner accordingly. That is, according to this embodiment of the present invention, there is provided a comparison unit or the like in the platform 340, for thereby determining whether or not an inputted temperature setting is an acceptable temperature, thus to enhance the processing speed and efficiency.

As so far described, the temperature control method and apparatus for a multi-type air conditioner according to the present invention can automatically control a setting temperature range for a multi-type air conditioner's operation within a desired temperature range and maintain control thereof, thereby enhancing energy efficiency. In addition, the temperature control method and apparatus for a multi-type air conditioner according to the present invention can control or block an undesirable temperature setting at any of the indoor units, thereby maintaining a pleasant indoor environment and enhancing energy efficiency.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present inventive features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A temperature control method for a multi-type air conditioner, comprising:
receiving, by a central control unit of the multi-type air conditioner, a desired temperature range inputted by a user at an indoor unit of the multi-type air conditioner;
comparing the inputted temperature range with a preset limit temperature range; and
if the inputted desired temperature range is within the preset limit temperature range, operating the indoor unit according to the inputted desired temperature range.

2. The method of claim 1, further comprising:
pre-setting the limit temperature range at the central control unit.

3. The method of claim 1, further comprising:
if the inputted desired temperature range is outside of the preset limit temperature range, re-inputting by the user an acceptable desired temperature range.

4. The method of claim 2, further comprising:
if the inputted desired temperature range is outside of the preset limit temperature range, outputting an error message.

5. A temperature control method for a multi-type air conditioner, comprising:
receiving, by a central control unit of the multi-type air conditioner, a desired temperature inputted by a user at an indoor unit of the multi-type air conditioner;
determining whether the inputted desired temperature is within a preset temperature range; and
operating the indoor unit based on the determination result.

6. The method of claim 5, wherein operating the indoor unit based on the determination result comprises operating the indoor unit at a previously set temperature, if the inputted desired temperature is outside the preset temperature range.

7. The method of claim 6, further comprising:
outputting an indication of the preset temperature range and an error message to the indoor unit.

8. The method of claim 5, wherein operating the indoor unit based on the determination result comprises operating the indoor unit according to the inputted temperature, if the inputted temperature is within the preset temperature range.

9. The method of claim 5, further comprising:
pre-setting the preset temperature range at the central control unit.

10. The method of claim 9, further comprising:
pre-setting a different preset temperature range at the central control unit for each of a plurality of indoor units.

11. The method of claim 5, further comprising:
re-setting the preset temperature range at the central control unit while the multi-type air conditioner is being operated.

12. A temperature control apparatus for a multi-type air conditioner, comprising:
a central control unit that receives a desired temperature range setting from an indoor unit, compares the received desired temperature range setting with a preset limit temperature range, and operates the indoor unit according to the inputted desired temperature range if the inputted desired temperature range is within the preset limit temperature range.

13. The temperature control apparatus according to claim 12, wherein the preset limit temperature range is preset at the central control unit.

14. The temperature control apparatus according to claim 12, wherein the central control unit sends an error message to the input unit if the inputted desired temperature range is outside of the preset limit temperature range.

15. A temperature control apparatus for a multi-type air conditioner, comprising:
a central control unit that receives a desired temperature from an indoor unit, determines whether the desired temperature is within a preset temperature range, and operates the indoor unit based on the determination result.

16. The temperature control apparatus according to claim 15, wherein the temperature control apparatus comprises the indoor unit, the central control unit sends the preset temperature range and an error message to the indoor unit when the desired temperature is not within the preset temperature range, and the indoor unit comprises and output unit that outputs an indication of the preset temperature range and the error message.

17. The temperature control apparatus according to claim 15, wherein the central control unit operates the indoor unit according to the desired temperature if the inputted temperature is within the preset temperature range.

18. The temperature control apparatus according to claim 15, wherein the central control unit comprises a setting unit that presets the preset temperature range.

19. The temperature control apparatus according to claim 18, wherein the setting unit presets a different preset temperature range for each of a plurality of indoor units of the multi-type air conditioner.
